(19) United States
(12) Patent Application Publication
(10) Pub. No.: US 2007/0219899 A1
(43) Pub. Date: Sep. 20, 2007

(54) Financial transaction facilitation financing method and system

(75) Inventor: James M. Neckopulos, Moraga, CA (US)

Correspondence Address: DUCKOR SPRADLING METZGER & WYNNE;A LAW CORPORATION, 3043 4th Ave., SAN DIEGO, CA, 92103, US

(73) Assignee: James M. Neckopulos

(21) Appl. No.: 11/378,806

(22) Filed: Mar. 17, 2006

(51) Int. Cl. G06Q 40/00

(52) U.S. Cl. 705/38

(57) ABSTRACT

A method and system are disclosed. The method may include providing a risk sharing negotiable document for a fixed amount for the purchase of the property to both a buyer and a seller of the property for a fixed period of time, acquiring a current value of the property at a repayment time of the risk sharing negotiable document, and allocating a buyer's share and a seller's share of the amount of the risk sharing negotiable document.

### BACKGROUND OF THE INVENTION

1. Field of the Invention

The present invention relates in general to the financing of purchases. It more particularly relates to a risk sharing financing method and system.

2. Background Art

There is no admission that the background art disclosed in this section legally constitutes prior art.

Buyers and sellers often disagree on the value of the property in a transaction. This is especially prevalent in the area of residential real estate in a falling or threatening to fall real estate market using current home financing instruments.

Home financing comes in a variety of shapes and sizes, such as first mortgages, second mortgages, fixed interest rates, variable interest rates, balloons, 15 year terms, 30 year terms, seller assisted, etc. A common thread between each of these instruments is that a buyer is liable to repay the entire amount of the loan. Some of the instruments may adjust periodic payments due to an increase or decrease in a specific economic indicator, but each of these instruments requires full repayment of the loan amount. With each of these instruments, the repayment amount of the loan is fixed at the time of the sale.

In a falling real estate market or rising interest rate market (which typically decreases the value of homes), this repayment requirement may reduce and/or slow the number of real estate transactions occurring in the market. Buyers will be hesitant to make too high of an offer for a particular home for fear that in a few years the value of this home may be lower than when they bought it, while the sellers want to get the current fair market value of their home. None of the currently available home financing instruments provides any protection to the buyer in the situation where the value of his home decreases over time or provides any way for the seller to adjust for this feeling by the buyer, other than to lower his asking price.

While the above describes involve the purchase of a piece of residential property between the buyer and the seller, other purchases of property, such as commercial real property, intellectual property, art, rare or vintage automobiles, other personal property, etc. may have some of these same issues.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a block diagram of an embodiment of a financial transaction facilitation financing system of the present invention including a broker, a financial facilitator, and a bank;

FIG. 2 is a block diagram of another embodiment of a financial transaction facilitation financing system including a broker and a bank;

FIG. 3. is a block diagram of yet another embodiment of a financial transaction facilitation financing system including a broker and a financial facilitator;

FIG. 4 is a block diagram of still another embodiment of a financial transaction facilitation financing system including a broker; and

FIG. 5 is a block diagram of another embodiment of a financial transaction facilitation financing system including a financial facilitator.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A method and system are disclosed, and may include a method of financing a purchase of property having a sales price. The method may include creating by means of a computer a risk sharing negotiable document for the purchase of the property by a buyer from a seller, the document defining an amount, a risk ratio for allocating the risk between the buyer and the seller for repayment of the amount at a repayment time; sending an appraisal request message to acquire a current value of the property at the repayment time of the risk sharing negotiable document; receiving an appraisal message indicative of the current value of the property; and determining by means of a computer a buyer's share and a seller's share of the amount of the risk sharing negotiable document based on the current value of the property relative to the sales price and the risk ratio.

In accordance with another disclosed embodiment of the invention, there is provided a method of financing a purchase of property having a sales price, which may include sending a terms message to a document preparer indicative of the negotiated terms of a risk sharing negotiable document between a buyer and a seller of the property, the terms including an amount of the risk sharing negotiable document and a risk assignment for repayment of the amount between the buyer and the seller; and causing the document preparer to create the risk sharing negotiable document. Upon occurrence of a termination event, an appraisal of a current value of the property is obtained and a buyer's share of repayment is calculated.

According to another aspect of a disclosed embodiment of the invention, there is provided a method of financing a purchase of property having a sales price. The method may include receiving a terms message including the terms of a risk sharing negotiable document between a buyer and a seller of a property, the terms including an amount of the risk sharing negotiable document and a risk assignment for repayment of the amount between the buyer and the seller; preparing the risk sharing negotiable document according to the terms; and sending a document message including the risk sharing negotiable document to an interested party. Upon occurrence of a termination event, an appraisal of a current value of the property is obtained and a buyer's share of repayment is calculated.

According to yet another aspect of a disclosed embodiment of the present invention, there is provided a method of financing a purchase of property having a sales price. The method may include receiving a message including a risk sharing negotiable document for a buyer and a seller of the property, the risk sharing negotiable document having an amount and a risk assignment for the repayment of the amount between the buyer and the seller; and placing the amount of the risk sharing negotiable document in a separate account. Upon occurrence of a termination event, an appraisal of a current value of the property is obtained and a buyer's share of repayment is calculated.

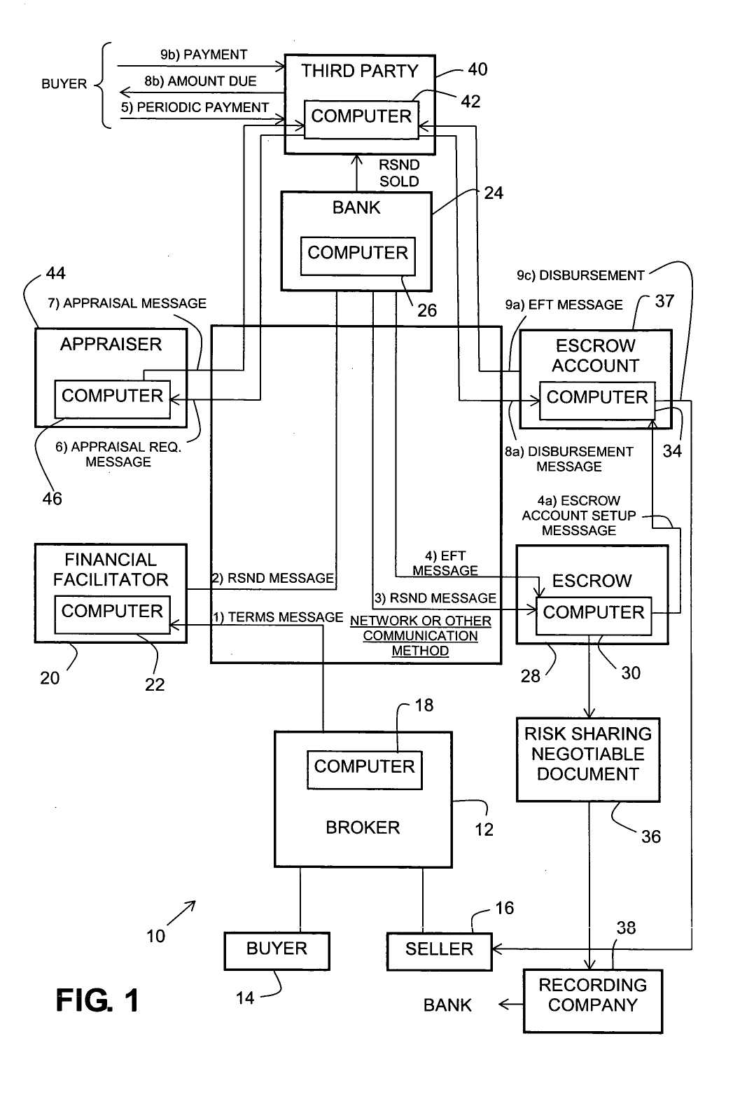

Referring to FIG. 1, an embodiment of the present invention as a buyer protection financing system is shown, generally referenced as 10. A real estate broker or agent 12 in their capacity of facilitating a sale of a home between a buyer 14 and a seller 16 may facilitate the negotiation of terms of a second mortgage between the buyer and the seller. The real estate broker 12 may be representing either the buyer 14 or the seller 16. The seller 16 may be an individual seller selling his or her residence or may be a builder or developer selling multiple residences. The real estate broker 12 may than transmit via a computer 18 a terms message containing these terms of this second mortgage to a computer 22 of a financial facilitator 20. The financial facilitator 20 may locate a bank 24 willing to provide a second mortgage according to the negotiated terms, prepare a risk sharing negotiable document according to the terms of the second mortgage, and forward a risk sharing negotiable document message containing the risk sharing negotiable document via the computer 22 to a computer 26 at the bank 24. The bank 24 may then review the document and forward the risk sharing negotiable document message containing the risk sharing negotiable document via the computer 26 to a computer 30 at an escrow company 28.

At closing the bank 24 may send an electronic funds transfer message via the computer 26 to the computer 30 at the escrow company 28. The escrow company 28 may then set up an escrow account 32 by sending an escrow account setup message to a computer 34 for the escrow account 32. The escrow account 32 may be with the bank, the escrow company, or some other financial institution. The escrow company 28 may print out the risk sharing negotiable document 36 for execution by the buyer 12 and seller 14. After execution by the buyer 12 and the seller 14, the risk sharing negotiable document 36 may be recorded by a recording company 38 and provided to the bank 24 as the holder of the risk sharing negotiable document 36. The buyer 12 may then begin making period interest only payments to the bank 24 for the full amount of the risk sharing negotiable document.

The terms of the risk sharing negotiable document may include an amount, a fixed time period, an interest rate, and an allocation of the repayment of the amount between the buyer and the seller based on a current value of the home at the termination of the second mortgage. Each of these terms may be negotiated between the buyer and the seller with compromises in one area by one party compensating for compromises in another area by the other party.

The amount of the risk sharing negotiable document may be any agreed to amount between the buyer and the seller, such as, for example, between about ten and about twenty percent of the sales price, and may be a compromise between an amount the seller may be at risk for and an amount the buyer feels the property may reduce in value.

The fixed period of time may determine the maximum length of time of the second mortgage, typically between three to five years. The actual term of the risk sharing negotiable document may be less than this fixed period of time due to a subsequent sale of the property by the buyer and/or by mutual agreement of the parties.

The interest rate may be a fixed or variable rate tied to a specific economic indicator. The buyer may make periodic interest only payments based on the amount of the risk sharing negotiable document to the holder of the risk sharing negotiable document.

The allocation of the repayment of the amount of the risk sharing negotiable document may provide liability to both the buyer and the seller for the amount of the risk sharing negotiable document. This allocation may share the risk of a reduction in the value of the home during the life of the risk sharing negotiable document between the buyer and the seller. This risk may be negotiated in the risk sharing negotiable document as a buyer's risk ratio and a seller's risk ratio. Each risk ratio may be referenced as a number between 0 and 1 or alternatively between 0 and 100% with the sum of the two risk ratios being equal to 1 or 100%, respectively. The allocation may include an appraisal by independent appraiser at the termination of the risk sharing negotiable document to determine a current value of the property. As discussed above this may occur at the end of the fixed period of time or at an earlier time mutually agreed to by the parties.

The allocation of a buyer's share of the amount of the risk sharing negotiable document may be calculated using the following formula:
BS=NDA−[(SP−CV)*(1−BRR)]
where BS is the buyer's share, NDA is the negotiable document amount, SP is the sales price of the property, CV is a current value of the property at a time of repayment of the amount of the risk sharing negotiable document, and BRR is the buyer's risk ratio. The buyer's share may be limited to the amount of the risk sharing negotiable document and may not be less than zero (buyer's protection may be limited to amount of the risk sharing negotiable document). The buyer's share may be determined using a computational device such as a computer, a calculator, or other computational aids.

The allocation of a seller's share of the amount of the risk sharing negotiable document be calculated using the following formula:
SS=(SP−CV)*SRR
where SS is the seller's share, SP is the sales price of the property, CV is a current value of the property at a time of repayment of the amount of the risk sharing negotiable document, and SRR is the seller's risk ratio. The seller's share may be limited to the amount of the risk sharing negotiable document and may not be less than zero (seller may not share in any increase in value of the property). The seller's share may also be calculated by subtracting the buyer's share from the amount of the risk sharing negotiable document. The seller's share may be determined using a computational device such as a computer, a calculator, or other computational aids.

The following tables provide examples of allocations for a risk sharing negotiable document in the amount of $100,000 between a buyer and a seller for the purchase of a home at a sales price of $500,000 and home value reductions of 10% to a current value of $450,000 (Table 1) and 30% to a current value of $350,000 (Table 2). In each table, the buyer's risk ratio (BRR) is shown in 10% increments from 0-90%. The buyer's share (BS) may be the amount the buyer pays to the holder of the risk sharing negotiable document at the termination of the risk sharing negotiable document and the amount the seller may receive. The seller's share (SS) shows the amount of the risk sharing negotiable document the seller may not receive. If the amount of the risk sharing negotiable document is being held in an escrow account, the seller may receive the BS amount from the escrow account at the termination of the risk sharing negotiable document.

TABLE 1
Current value = $450,000

| BRR | BS | SRR | SS |
|---|---|---|---|
| 0% | $50,000 | 100% | $50,000 |
| 10% | $55,000 | 90% | $45,000 |
| 20% | $60,000 | 80% | $40,000 |
| 30% | $65,000 | 70% | $35,000 |
| 40% | $70,000 | 60% | $30,000 |
| 50% | $75,000 | 50% | $25,000 |
| 60% | $80,000 | 40% | $20,000 |
| 70% | $85,000 | 30% | $15,000 |
| 80% | $90,000 | 20% | $10,000 |
| 90% | $95,000 | 10% | $5,000 |

TABLE 2
Current Value = $350,000

| BRR | BS | SRR | SS |
|---|---|---|---|
| 0% | $ — | 100% | $100,000 |
| 10% | $ — | 90% | $100,000 |
| 20% | $ — | 80% | $100,000 |
| 30% | $ — | 70% | $100,000 |
| 40% | $10,000 | 60% | $90,000 |
| 50% | $25,000 | 50% | $75,000 |
| 60% | $40,000 | 40% | $60,000 |
| 70% | $55,000 | 30% | $45,000 |
| 80% | $70,000 | 20% | $30,000 |
| 90% | $85,000 | 10% | $15,000 |

Other terms of the risk sharing negotiable document may also be negotiated by the parties, such as a process for selecting an independent appraiser, a process for adjusting the time period of the risk sharing negotiable document, a periodic payment method, a minimum time period for the risk sharing negotiable document where the seller may be responsible for the full value of the risk sharing negotiable document regardless of the current value of the property, a time period after which the buyer may unilaterally set a termination date of the risk sharing negotiable document, etc.

As a potential holder of the risk sharing negotiable document, the bank 24 may sell the risk sharing negotiable document to a third party 40, typically at a discount of the full amount of the risk sharing negotiable document. The third party 40, now the holder of the risk sharing negotiable document 36 and typically another bank or financial institution, may then take the place of the bank 24 and receive the periodic payments from the buyer 12 and all other payments from either the buyer 12 and/or the escrow account 32. The third party 40 may also sell the risk sharing negotiable document to yet another party.

Subsequent the termination of the risk sharing negotiable document, the third party 40 may send via a computer 42 an appraisal request message to a computer 46 of an appraiser 44 to obtain an appraisal of a current value of the property. The appraiser 44 appraises the property and may provide via the computer 46 an appraisal message to the computer 42 of the third party 40 containing the current value of the property. The computer 42 of the third party 40 then may calculate the share values as described above and may send via the computer 42 a disbursement message to the computer 34 of the escrow account 32 providing instructions for disbursing the funds in the escrow account 32 at the termination of the risk sharing negotiable document 36 between the third party 40 and the seller 14. The third party 40 may also notify the buyer 12 of his share of the amount of the risk sharing negotiable document 36.

At the termination of the risk sharing negotiable document 36, the seller 14 may receive his share of funds from the escrow account 32, and the computer 42 at the third party 40 may receive an electronic funds transfer message from the computer 34 of the escrow account 32 for the balance of the escrow account 32. The buyer 12 may then also provide payment to the third party 40 in the amount of the buyer's share. With the transfer from the escrow account 32 and this payment from the buyer 12, the third party 40 may receive the full amount of the risk sharing negotiable document 36.

If the bank 24 (or holder of the risk sharing negotiable document) does not sell the risk sharing negotiable document 36 and remains the holder of the risk sharing negotiable document 36, the bank 36 may perform and receive payment as described above regarding the third party 40.

It is envisioned that the financial facilitator may provide the real estate broker the ability to prepare the risk sharing negotiable document. The real estate broker may then locate the bank and provide the risk sharing negotiable document to the bank directly.

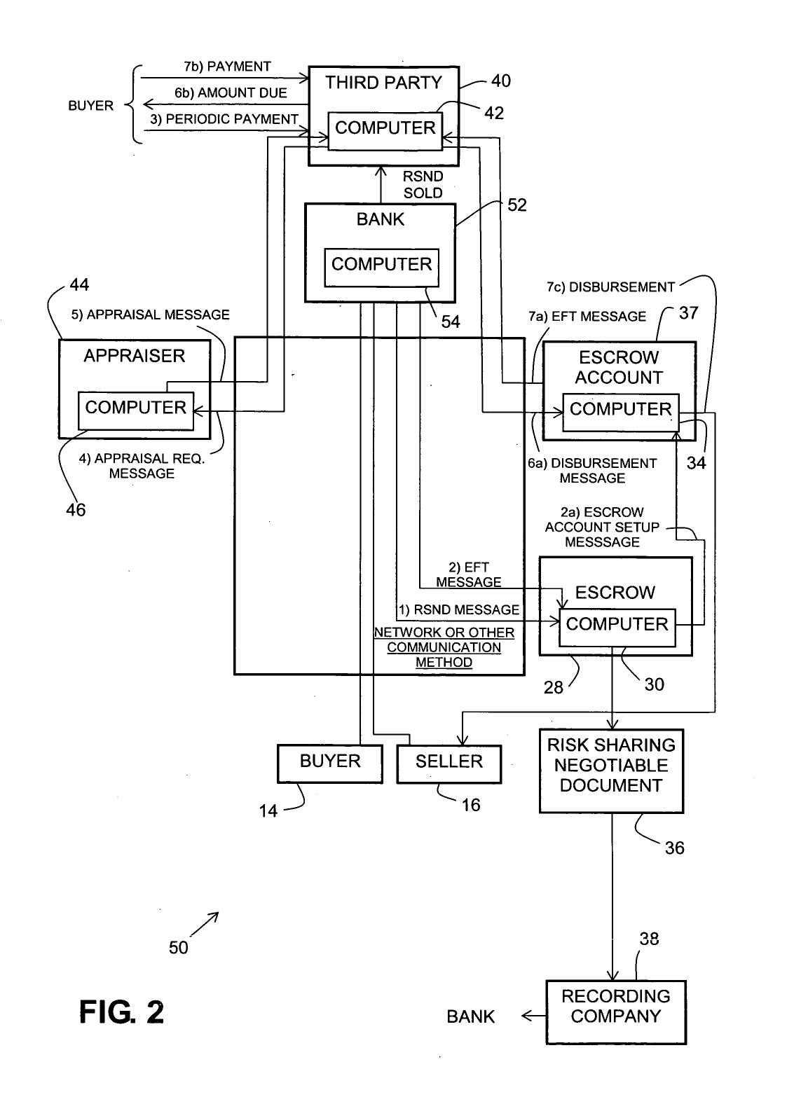

Referring now to FIG. 2, another embodiment of the present invention as a buyer protection financing system is shown, generally referenced as 50. A bank 52 may provide a risk sharing second mortgage product to facilitate a sale of a piece of property between a buyer 14 and a seller 16. The bank 52 may negotiate terms of the second mortgage product between the buyer 14 and the seller 16. The seller 16 may be an individual seller selling his or her residence or may be a builder or developer selling multiple residences. The bank 52 may then prepare a risk sharing negotiable document according to the terms of the second mortgage, and forward a risk sharing negotiable document message containing the risk sharing negotiable document via the computer 54 to a computer 30 at an escrow company 28.

The terms of the risk sharing negotiable document and all subsequent activities regarding the risk sharing negotiable document may be identical to those described above in relation to the embodiment of FIG. 1.

In the embodiments of FIGS. 1 and 2 above, the third party of the bank may receive the interest only payments from the buyer during the life of the risk sharing negotiable document and receive the seller's share from the escrow account at the termination of the risk sharing negotiable document, while assuming the risk of receiving the buyer's share of the risk sharing negotiable document from the buyer at the termination of the risk sharing negotiable document. The seller may not receive the interest only payments from the buyer, but may be assured of receiving the buyer's share at the termination of the risk sharing negotiable document from the escrow account.

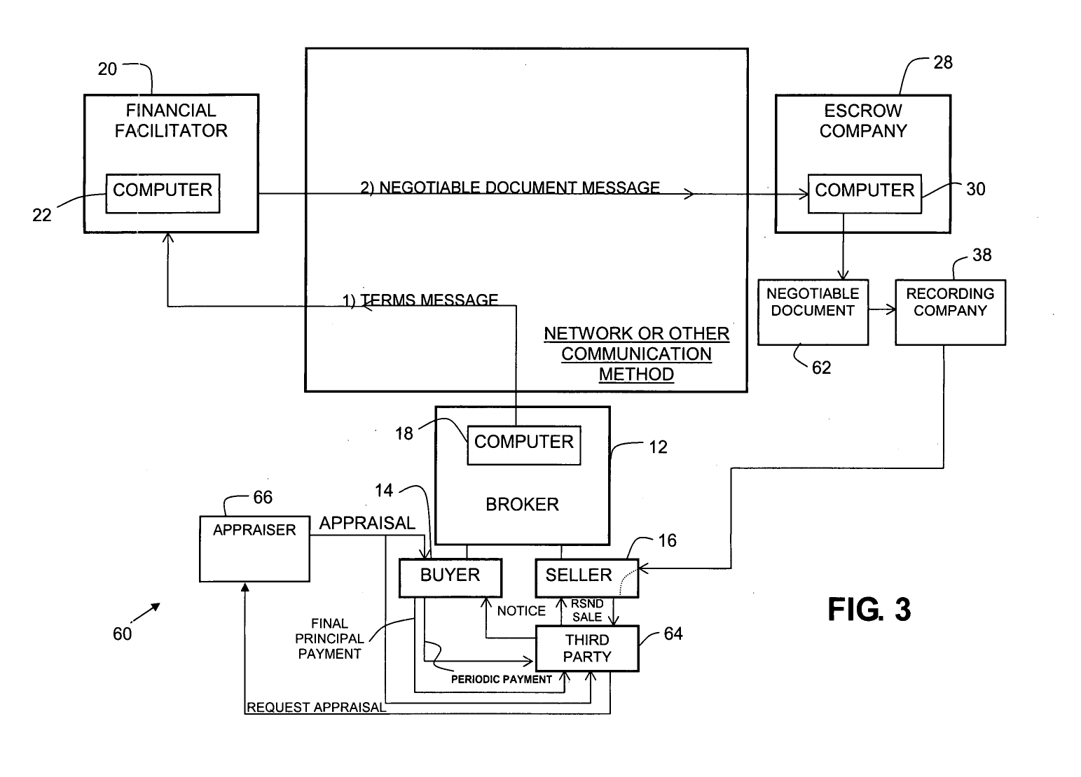

Referring to FIG. 3, an embodiment of the present invention as a buyer protection financing system is shown, generally referenced as 60. A real estate broker or agent 12 in their capacity of facilitating a sale of a home between a buyer 14 and a seller 16 may negotiate terms of a second mortgage between the buyer 14 and the seller 16. The real estate broker 12 may be representing either the buyer 14 or the seller 16. The seller 16 may be an individual seller selling his or her residence or may be a builder or developer selling multiple residences. The real estate broker 12 may then transmit via a computer 18 a terms message containing these terms of this second mortgage to a computer 22 of a financial facilitator 20. The financial facilitator 20 may prepare a risk sharing negotiable document according to the terms of the second mortgage and forward a risk sharing negotiable document message containing the risk sharing negotiable document via the computer 22 to a computer 30 at an escrow company 28.

Prior to the closing the escrow company 28 may print out the risk sharing negotiable document 62 for execution by the buyer 14 and seller 16. After execution by the buyer 14 and the seller 16, the risk sharing negotiable document 62 may be recorded by a recording company 38 and provided to the seller 16 as the holder of the risk sharing negotiable document 62. The buyer 14 may then begin making period interest only payments to the seller 16 for the full amount of the risk sharing negotiable document 62.

The terms of the risk sharing negotiable document may be identical to those described above in regard to the risk sharing negotiable document of the embodiment of FIG. 1.

As the holder of the risk sharing negotiable document 62, the seller 16 may sell the risk sharing negotiable document 62 to a third party 64, typically at a discount of the full amount of the risk sharing negotiable document 62. The third party 64, now the holder of the risk sharing negotiable document 64, may then take the place of the seller 16 and receive the periodic payments from the buyer 14 and the buyer's share payment at the termination of the risk sharing negotiable document 62. The third party 64 may also sell the risk sharing negotiable document 62 to yet another party.

Subsequent the termination of the risk sharing negotiable document 62, an independent appraiser 66 may be contacted by either the third party 64 or the buyer 14 to obtain an appraisal of a current value of the property. The appraiser 66 may appraise the property and provide a report containing the current value of the property to the third party 64 and the buyer 14. The third party 64 and/or the buyer 14 may then calculate the buyer's share value as described above.

At the termination of the risk sharing negotiable document 62, the buyer 14 may provide payment to the third party 64 in the amount of the buyer's share. With a decrease in the value of the property, the third party 64 may receive less than the full amount of the risk sharing negotiable document 62. If the value of the property does not decrease, the third party 64 may receive the full amount of the risk sharing negotiable document 62.

If the seller 16 does not sell the risk sharing negotiable document 62 and remains the holder of the risk sharing negotiable document 62, the seller 16 may perform and receive payment as described above regarding the third party 64.

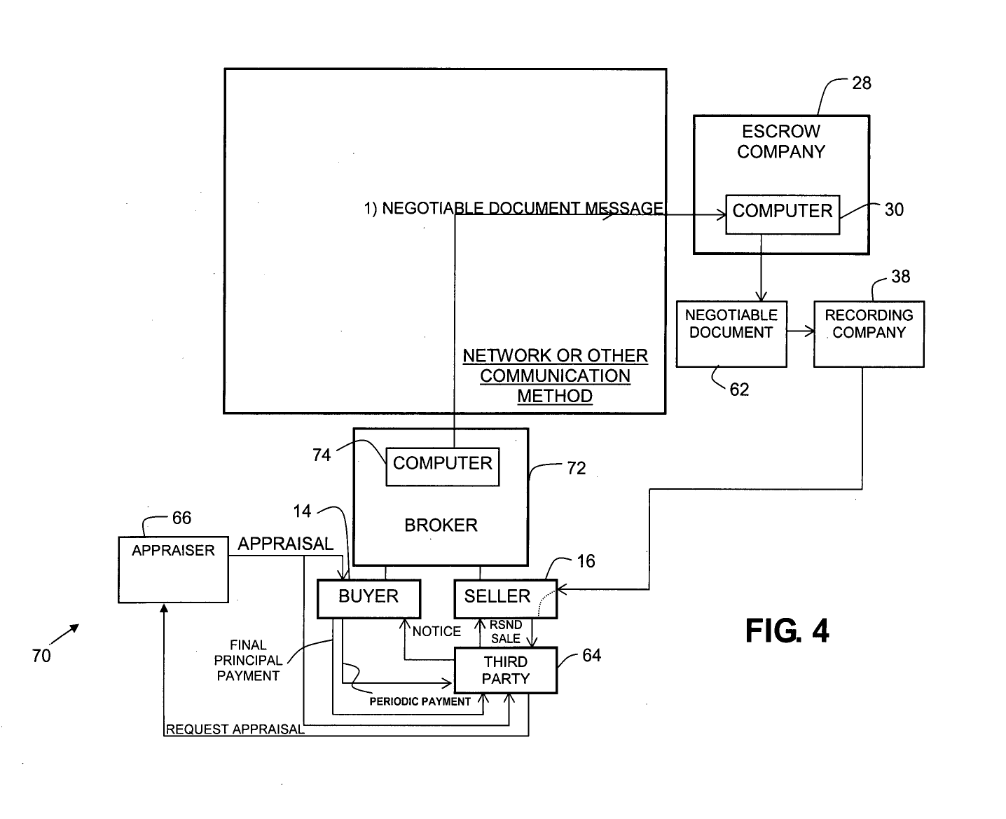

Referring to FIG. 4, an embodiment of the present invention as a buyer protection financing system is shown, generally referenced as 70. A real estate broker or agent 72 in their capacity of facilitating a sale of a home between a buyer 14 and a seller 16 may negotiate terms of a second mortgage between the buyer 14 and the seller 16. The real estate broker 72 may be representing either the buyer 14 or the seller 16. The seller 16 may be an individual seller selling his or her residence or may be a builder or developer selling multiple residences. The real estate broker 72 may then prepare a risk sharing negotiable document according to the terms of the second mortgage and forward a risk sharing negotiable document message containing the risk sharing negotiable document via a computer 74 to a computer 30 at an escrow company 28.

The terms of the risk sharing negotiable document and all subsequent activities regarding the risk sharing negotiable document may be identical to those described above in relation to the embodiment of FIG. 3.

The escrow company in the embodiments of FIG. 1-4 may be a title company, the bank, another financial institution, or a party agreed to by the buyer and the seller. In some circumstances, an escrow company may not be utilized at all with those activities performed, if done at all, by one of the other parties in the transaction.

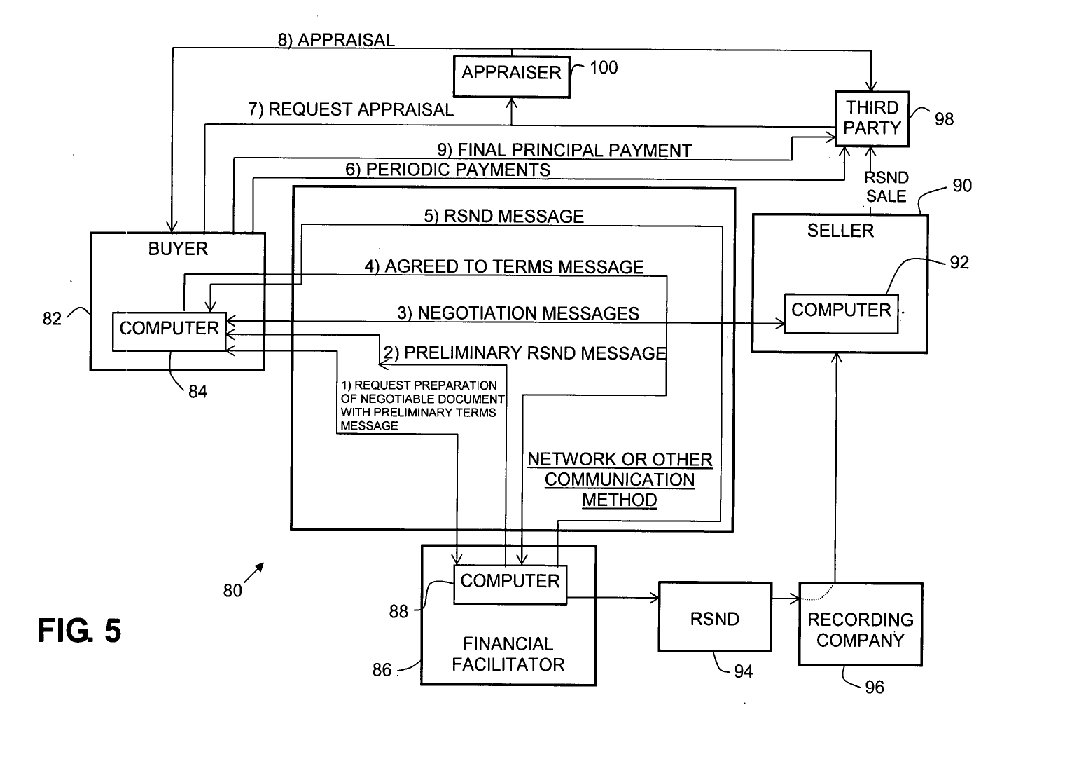

Referring now to FIG. 5, another embodiment of the present invention as a buyer protection financing system is shown, generally reference as 80. A buyer 82 may send via a computer 84 a request for preparation of a risk sharing negotiable document having preliminary terms message to a computer 88 at a financial facilitator 86 to help bring about a purchase of property from a seller 90. The financial facilitator 86 may prepare a preliminary risk sharing negotiable document and forward a preliminary risk sharing negotiable document message via the computer 88 to the computer 84 of the buyer 82. The buyer 82 may then use the preliminary risk sharing negotiable document in negotiation messages between the buyer 82 and the seller 90 regarding the purchase of the property. These negotiation messages may be transmitted between the computer 84 of the buyer 82 and a computer 92 of the seller 90. Upon mutual agreement of the terms of in the preliminary risk sharing negotiable document, the buyer 82 may provide via the computer 84 these agreed to terms in a request for the preparation of a risk sharing negotiable document message to the computer 88 of the financial facilitator 86. The financial facilitator 86 may prepare the risk sharing negotiable document and print out the risk sharing negotiable document 94 for execution by the buyer 82 and seller 90. After execution by the buyer 82 and the seller 90, the risk sharing negotiable document 94 may be recorded by a recording company 96 and provided to the seller 90 as the holder of the risk sharing negotiable document 94. The buyer 82 may then begin making period interest only payments to the seller 90 for the full amount of the risk sharing negotiable document 94.

The terms of the risk sharing negotiable document may be identical to those described above in regard to the risk sharing negotiable document of the embodiment of FIG. 1.

As the holder of the risk sharing negotiable document 94, the seller 90 may sell the risk sharing negotiable document 94 to a third party 98, typically at a discount of the full amount of the risk sharing negotiable document 94. The third party 98, now the holder of the risk sharing negotiable document 94, may then take the place of the seller 90 and receive the periodic payments from the buyer 82 and the buyer's share payment at the termination of the risk sharing negotiable document 94. The third party 98 may also sell the risk sharing negotiable document 94 to yet another party.

Subsequent the termination of the risk sharing negotiable document 94, an independent appraiser 100 may be contacted by either the third party 98 or the buyer 82 to obtain an appraisal of a current value of the property. The appraiser 100 may appraise the property and provide a report containing the current value of the property to the third party 98 and the buyer 82. The third party 98 and/or the buyer 82 may then calculate the buyer's share value as described above.

At the termination of the risk sharing negotiable document 94, the buyer 82 may provide payment to the third party 98 in the amount of the buyer's share. With a decrease in the value of the property, the third party 98 may receive less than the full amount of the risk sharing negotiable document 94. If the value of the property does not decrease, the third party 98 may receive the full amount of the risk sharing negotiable document 94.

If the seller 90 does not sell the risk sharing negotiable document 94 and remains the holder of the risk sharing negotiable document 94, the seller 90 may perform and receive payment as described above regarding the third party 98.

The seller 90 may also initiate contact with the financial facilitator 86 to help to bring about the sale of property to the buyer 82. Furthermore, the financial facilitator 86 may assist with the negotiation of the terms of the risk sharing negotiable document 94 between the buyer 82 and the seller 90.

In the embodiments of FIGS. 3-5 above, the third party or the seller may receive the interest only payments from the buyer during the life of the risk sharing negotiable document, while having the risk of receiving the buyer's share of the risk sharing negotiable document from the buyer at the termination of the risk sharing negotiable document.

The network or other communication method shown in FIGS. 1-5 may be the Internet or some other electronic communication network. It may also include facsimiles, telephone communication, letters through the mail, or even personal contact.

The descriptions of the above embodiments involve the purchase of a piece of residential property between the buyer and the seller. However, it is envisioned that this method and system of financing may be applicable to other purchases of property, such as but not limited to commercial real property, intellectual property, art, rare or vintage automobiles, other personal property, etc. Therefore, the broker may be a real estate broker, a mortgage broker, an art broker, etc. The escrow company or equivalent in these types of transactions may or may not be utilized.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A method of financing a purchase of property having a sales price, comprising
creating by means of a computer a risk sharing negotiable document for the purchase of the property by a buyer from a seller, the document defining an amount, a risk ratio for allocating the risk between the buyer and the seller for repayment of the amount at a repayment time;
sending an appraisal request message to acquire a current value of the property at the repayment time of the risk sharing negotiable document;
receiving an appraisal message indicative of the current value of the property; and
determining by means of a computational device a buyer's share and a seller's share of the amount of the risk sharing negotiable document based on the current value of the property relative to the sales price and the risk ratio.

2. The method of claim 1, further comprising
placing the amount of the risk sharing negotiable document in a separate account.

3. The method of claim 1, further comprising
receiving periodic payments from the buyer.

4. The method of claim 1, further comprising
selling the risk sharing negotiable document to a third party.

5. The method of claim 1, wherein the current value of the property is received from an independent appraiser.

6. The method of claim 1, wherein the buyer's share is calculated by the following formula: BS=NDA−[(SP−CV)*(1−BRR)], where BS is the buyer's share, NDA is the amount of the risk sharing negotiable document, SP is the sales price of the property, CV is the current value of the property, and BRR is a buyer's risk ratio.

7. The method of claim 1, wherein the seller's share is calculated by the following formula: SS=(SP−CV)*SRR, where SS is the seller's share, SP is the sales price of the property, CV is the current value of the property, and SRR is a seller's risk ratio.

8. The method of claim 1, wherein the seller's share is limited to the amount of the risk sharing negotiable document.

9. The method of claim 1, wherein the buyer's share is equal to the amount of the risk sharing negotiable document if the current value of the property is greater than the sales price of the property.

10. The method of claim 1, wherein the amount of the risk sharing negotiable document is between about 10 to about 20 percent of the sales price.

11. The method of claim 1, wherein the fixed period of time is between 3 to 5 years.

12. The method of claim 1, further providing a first mortgage for the purchase of the property.

13. The method of claim 1, wherein the fixed period of time can be modified upon mutual agreement of the buyer and the seller.

14. The method of claim 1, further including receiving interest only payments on the amount of the risk sharing negotiable document from the buyer.

15. The method of claim 1, further including placing the amount of the risk sharing negotiable document in an escrow account.

16. A method of financing a purchase of property having a sales price, comprising
sending a terms message to a document preparer indicative of the negotiated terms of a risk sharing negotiable document between a buyer and a seller of the property, the terms including an amount of the risk sharing negotiable document and a risk assignment for repayment of the amount between the buyer and the seller; and
causing the document preparer to create the risk sharing negotiable document,
wherein upon occurrence of a termination event, an appraisal of a current value of the property is obtained and a buyer's share of repayment is calculated.

17. The method of claim 16, wherein the risk assignment includes the buyer's share having a buyer's risk ratio and a seller's share having a seller's risk ratio.

18. The method of claim 17, wherein the buyer's share is calculated by the following formula: BS=NDA−[(SP−CV)*(1−BRR)], where BS is the buyer's share, NDA is the amount of the risk sharing negotiable document, SP is the sales price of the property, CV is a current value of the property at a time of repayment of the amount of the risk sharing negotiable document, and BRR is the buyer's risk ratio.

19. The method of claim 17, wherein the seller's share is calculated by the following formula: SS=(SP−CV)*SRR, where SS is the seller's share, SP is the sales price of the property, CV is a current value of the property at a repayment time of the amount of the risk sharing negotiable document, and SRR is the seller's risk ratio.

20. The method of claim 16, wherein the terms further include a fixed time period and an interest rate term.

21. The method of claim 16, further including receiving a document message including the risk sharing negotiable document.

22. A method of financing a purchase of property having a sales price, comprising
receiving a terms message including the terms of a risk sharing negotiable document between a buyer and a seller of a property, the terms including an amount of the risk sharing negotiable document and a risk assignment for repayment of the amount between the buyer and the seller;
preparing the risk sharing negotiable document according to the terms; and
sending a document message including the risk sharing negotiable document to an interested party,
wherein upon occurrence of a termination event, an appraisal of a current value of the property is obtained and a buyer's share of repayment is calculated.

23. The method of claim 22, wherein the interested party is an escrow company.

24. The method of claim 22, wherein the interested party is a financial institution.

25. A method of financing a purchase of property having a sales price, comprising
receiving a message including a risk sharing negotiable document for a buyer and a seller of the property, the risk sharing negotiable document having an amount and a risk assignment for the repayment of the amount between the buyer and the seller; and
placing the amount of the risk sharing negotiable document in a separate account,
wherein upon occurrence of a termination event, an appraisal of a current value of the property is obtained and a buyer's share of repayment is calculated.

26. A method of implementing a risk sharing negotiable document for an amount for a fixed period of time for a purchase of property having a sales price, comprising
allocating risk of a reduction in value of the property below the sales price between a buyer and a seller of the property;
obtaining an appraisal of a current value of the property near the end of the fixed period of time; and
calculating share values for the amount of the risk sharing negotiable document for both the buyer and the seller.

27. The method of claim 26, further including requiring the buyer to make interest payments on the amount of the risk sharing negotiable document.

28. The method of claim 26, further including placing the amount of the risk sharing negotiable document in an escrow account.

29. The method of claim 26, wherein the share values are calculated using the sales price of the property, the current value of the property, and the amount of the risk sharing negotiable document.

30. A device for financing a purchase of property having a sales price, comprising
means for receiving the terms of a risk sharing negotiable document between a buyer and a seller of a property, the terms including an amount of the risk sharing negotiable document and a risk assignment for repayment of the amount between the buyer and the seller;
means for preparing a note according to the terms of the risk sharing negotiable document; and
means for transmitting the note to a third party.

31. A device for financing a purchase of property having a sales price, comprising
means for receiving a risk sharing negotiable document for a buyer and a seller of the property, the risk sharing negotiable document having an amount and a risk assignment for the repayment of the amount between the buyer and the seller; and
means for placing the amount of the risk sharing negotiable document in a separate account.

32. A device for implementing a risk sharing negotiable document for an amount for a fixed period of time for a purchase of property having a sales price, comprising
means for allocating risk of a reduction in value of the property below the sales price between a buyer and a seller of the property;
means for obtaining an appraisal of a current value of the property near the end of the fixed period of time; and
means for calculating share values for the amount of the risk sharing negotiable document for both the buyer and the seller.
